(19) United States
(12) Patent Application Publication
(10) Pub. No.: US 2004/0237392 A1
(43) Pub. Date: Dec. 2, 2004

(54) Frost protector grate

(76) Inventor: Norine Juliet Donoghue, Detroit, MI (US)

Correspondence Address: Norine J. Donoghue, 19900 Woodbine St., Detroit, MI, 48219, US

(21) Appl. No.: 10/400,033

(22) Filed: Jun. 2, 2003

(51) Int. Cl. A01G 17/06

(52) U.S. Cl. 47/45

(57) ABSTRACT

A protective grate assembly includes a metal grate, and a shroud that is laid on a protected foliage. The grate holds the shroud beneath the grate, and above the foliage.

### BACKGROUND AND SUMMARY OF THE INVENTION

This invention is concerned with protecting foliage and growing plants during the fall and spring from frost damage, and more Particularly to a system in which newspapers or a sheet of cloth are gently placed over the plants and then held in a position by a hold-down structure.

The purpose of the present invention is to provide a hold-down arrangement in which a protective material is laid on a plant. A metal grate holds the protective material in position on the plant.

Still further objects and advantages of the invention will become readily apparent to those skilled in the art to which the invention pertains.

### DESCRIPTION OF THE DRAWINGS

The description refers to the accompanying drawings in which like reference characters refer to like parts through the several views, and in which:

FIG. 1 is a plan view of a preferred hold-down grate;

FIG. 2 is a view of a corner of the hold-down grate to show one of the pivotal legs; and

FIG. 3 is a perspective view of the hold-down grate and shroud.

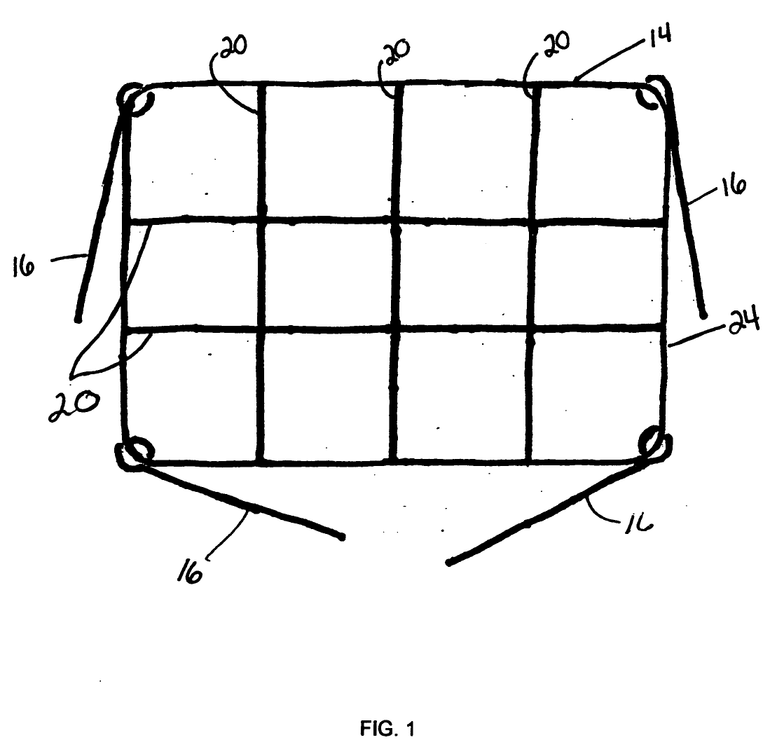

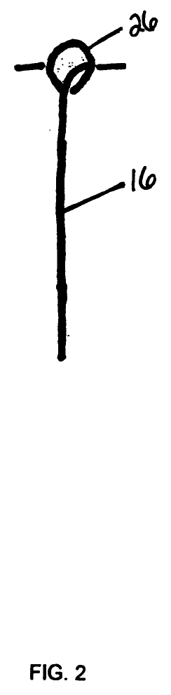

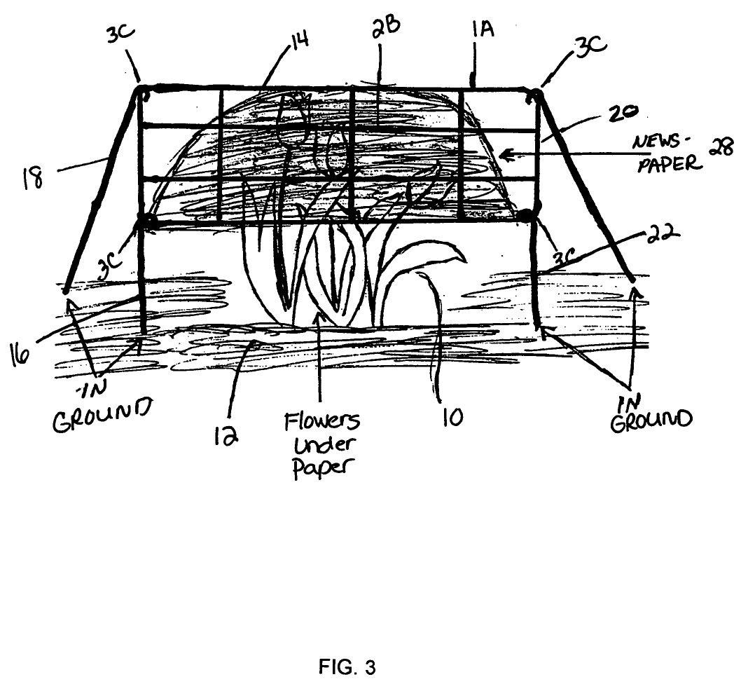

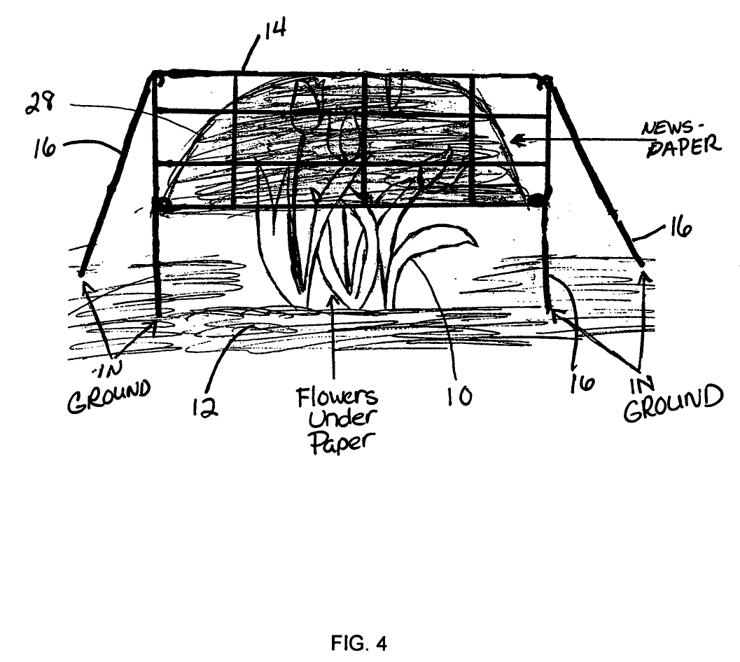

### DESCRIPTION OF THE PREFERRED EMBODIMENT

Referring to the drawings, the preferred embodiment is intended to be used on flowers or other growing foliage 10 growing from soil 12. The hold-down assembly includes a grate 14 supported on a plurality of prongs 16. The prongs are inserted into the around to support the grate above the foliage. Preferably the grate has four to five crisscross wires 20 carried on a rectangular frame 24. The grate is made of wire. Preferably coated with a vinyl covering or painted with a rust proof paint for continued use.

Each of the around prongs has an upper end having a loop 26 which permits the prong to be tucked under close to the grate for easy storage, when not in use.

A newspaper or other suitable protective material such as a cloth, is carefully laid on the foliage to form a shroud 28 over the protected foliage life. The prongs permit the height of the grate to be adiusted to accommodate plant size and condensibility for convenient storage. The grate is then mounted over both the foliage and the shroud without severely bending the foliage.

Having described my invention, I claim:

1. (Canceled)

2. (Canceled)

3. A protective grate combination for covering and protecting a foliage, comprising:
a loose shroud for placing on the selected foliage in a position spaced above the ground;
a grate of rigid bars;
a plurality of stiff legs each having an upper end pivotally connected to the grate, and a lower prong for partially inserting the leg in the soil;
whereby the grate can be disposed on the legs in a position spaced above the soil to retain the shroud in place on the foliage.

4. A protective grate combination as defined in claim 3, in which the shroud is formed of newspaper.

5. A protective grate combination as defined in claim 3, in which the shroud is formed of a cloth material.

6. A protective grate combination as defined in claim 3, in which the grate has a four-sided structure, and the legs are pivotally connected to the four-sided structure so as to be movable between a position in which the legs support the structure above a ground surface, and a pivoted position folded under the structure for storage.

7. A protective grate combination as defined in claim 3, in which each of the legs has an upper loop connected to the grate, and a lower prong.
